(19) United States
(12) Patent Application Publication
(10) Pub. No.: US 2025/0372898 A1
(43) Pub. Date: Dec. 4, 2025

(54) TERMINAL BLOCK

(71) Applicant: Yazaki Corporation, Tokyo (JP)

(72) Inventors: Yasuhiro TANAKA, Shizuoka (JP); Yasuhiro OTSUTA, Shizuoka (JP); Masatoshi YAMADA, Shizuoka (JP); Shogo FURUI, Shizuoka (JP); Shinya TACHIBANA, Shizuoka (JP)

(73) Assignee: Yazaki Corporation, Tokyo (JP)

(21) Appl. No.: 19/200,799

(22) Filed: May 7, 2025

(30) Foreign Application Priority Data
May 28, 2024 (JP) 2024-086081

(51) Int. Cl. H01R 9/22; H01R 9/24

(52) U.S. Cl. CPC H01R 9/223; H01R 9/226; H01R 9/24

(57) ABSTRACT

A terminal block includes a bus bar, a housing provided with an insertion space portion into which a second connection portion of the bus bar is inserted along an axial direction, a packing inserted into the insertion space portion together with the second connection portion and sealing an annular space between an outer surface of the second connection portion and an inner surface of the insertion space portion, and a packing holder provided with a bus bar insertion portion into which the second connection portion is inserted along the axial direction, and is inserted into the insertion space portion in a state where the second connection portion is inserted into the bus bar insertion portion and the packing is supported in the axial direction, in which the bus bar insertion portion is configured to include a first gap for allowing deformation of the second connection portion.

### CROSS-REFERENCE TO RELATED APPLICATION(S)

The present application claims priority to and incorporates by reference the entire contents of Japanese Patent Application No. 2024-086081 filed in Japan on May 28, 2024.

### BACKGROUND OF THE INVENTION

### 1. Field of the Invention

The present invention relates to a terminal block.

### 2. Description of the Related Art

As a technique related to a terminal block in the related art, for example, JP 2022-024667 A discloses a terminal block including a bus bar provided with a first connection portion connected to a first connection terminal, a second connection portion connected to a second connection terminal, and an intermediate portion connected between the first connection portion and the second connection portion; and a housing provided with an insertion space portion into which the second connection portion of the bus bar is inserted.

Here, the terminal block disclosed in JP 2022-024667 A has room for further improvement in terms of absorbing a tolerance between the first connection terminal and the second connection terminal, for example.

### SUMMARY OF THE INVENTION

The present invention has been made in view of the above circumstances, and an object of the present invention is to provide a terminal block capable of absorbing a tolerance between a first connection terminal and a second connection terminal.

In order to achieve the above mentioned object, a terminal block according to one aspect of the present invention includes a bus bar including a first connection portion extending along an axial direction and connected to a first connection terminal, a second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and extending along the plate thickness direction; a housing provided with an insertion space portion into which the second connection portion of the bus bar is inserted along the axial direction; a packing that is inserted into the insertion space portion together with the second connection portion and seals an annular space between an outer surface of the second connection portion and an inner surface of the insertion space portion; and a packing holder provided with a bus bar insertion portion through which the second connection portion is inserted along the axial direction, the packing holder being inserted into the insertion space portion in a state where the second connection portion is inserted into the bus bar insertion portion, and the packing is supported in the axial direction, wherein the bus bar insertion portion is configured to include a first gap for allowing deformation of the second connection portion in the plate thickness direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a terminal block according to an embodiment;

FIG. 2 is an exemplary exploded perspective view of the terminal block according to the embodiment;

FIG. 3 is an exemplary perspective view of a packing of the terminal block according to the embodiment;

FIG. 4 is an exemplary perspective view of a packing holder of the terminal block according to the embodiment;

FIG. 5 is an exemplary sectional view of the terminal block according to the embodiment; and

FIG. 6 is an exemplary sectional view of the terminal block according to the embodiment in a state where the bus bar is deformed.

### DETAILED DESCRIPTION OF THE PREFERRED EMBODIMENTS

Hereinafter, embodiments according to the present invention will be described in detail with reference to the drawings. Note that the present invention is not limited by the following embodiments. In addition, constituent elements in the following embodiments include those that can be easily replaced by those skilled in the art, or those that are substantially the same. In the present specification, ordinal numbers are used only to distinguish components, members, parts, positions, directions, and the like, and do not indicate order or priority.

### Embodiment

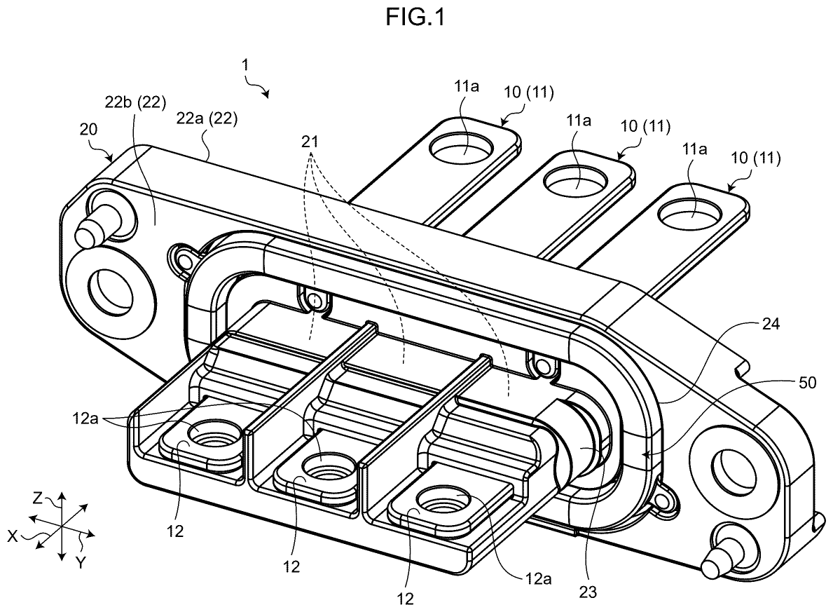

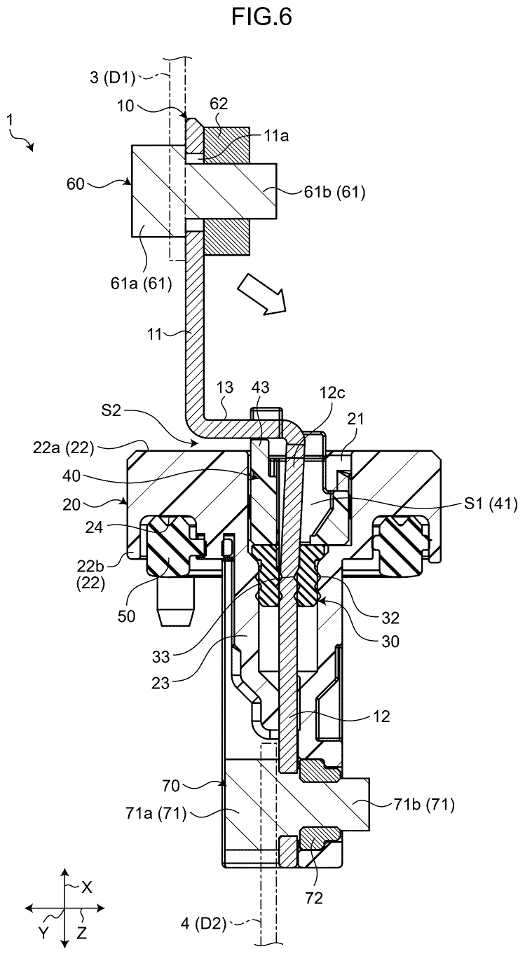

FIG. 1 is a perspective view of a terminal block 1 according to an embodiment. The terminal block 1 of the present embodiment illustrated in FIG. 1 is mounted on a vehicle such as an electric car or a hybrid car, for example, and relays electrical connection between a first device D1 and a second device D2. The terminal block 1 of the present embodiment includes a plurality of bus bars 10, and a first connection terminal 3 (refer to FIG. 6) of the first device D1 is electrically connected to a first connection portion 11 provided at one end portion of the plurality of bus bars 10. In the terminal block 1 of the present embodiment, a second connection terminal 4 of the second device D2 is electrically connected to a second connection portion 12 provided at the other end portion of the plurality of bus bars 10. The first device D1 is, for example, one of a motor and an inverter, and the second device D2 is, for example, the other of the motor and the inverter. Note that the terminal block 1 is not limited to this example, and may be used for, for example, relaying between the first device D1 or the second device D2 and a wiring member, relaying between the wiring member and the wiring member, or the like.

In the following description, among a first direction, a second direction, and a third direction intersecting each other, the first direction is referred to as an “axial direction X”, the second direction is referred to as a “width direction Y”, and the third direction is referred to as a “plate thickness direction Z”. Here, the axial direction X, the width direction Y, and the plate thickness direction Z are substantially orthogonal to each other. Typically, the axial direction X corresponds to an extending direction of the plurality of bus bars 10, an insertion direction of the plurality of bus bars 10 into a housing 20, a depth direction (front-rear direction) of the terminal block 1, or the like. The width direction Y typically corresponds to a width direction of the plurality of bus bars 10, a width direction (left-right direction) of the terminal block 1, or the like. The plate thickness direction Z typically corresponds to a plate thickness direction of the plurality of bus bars 10 (the first connection portion 11 and the second connection portion 12), a fastening direction of the plurality of bus bars 10 and the first connection terminal 3 and the second connection terminal 4, a height direction (vertical direction) of the terminal block 1, or the like. Each direction used in the following description will be described as a direction in a state where the terminal block 1 is assembled to the first connection terminal 3 and the second connection terminal 4 unless otherwise specified.

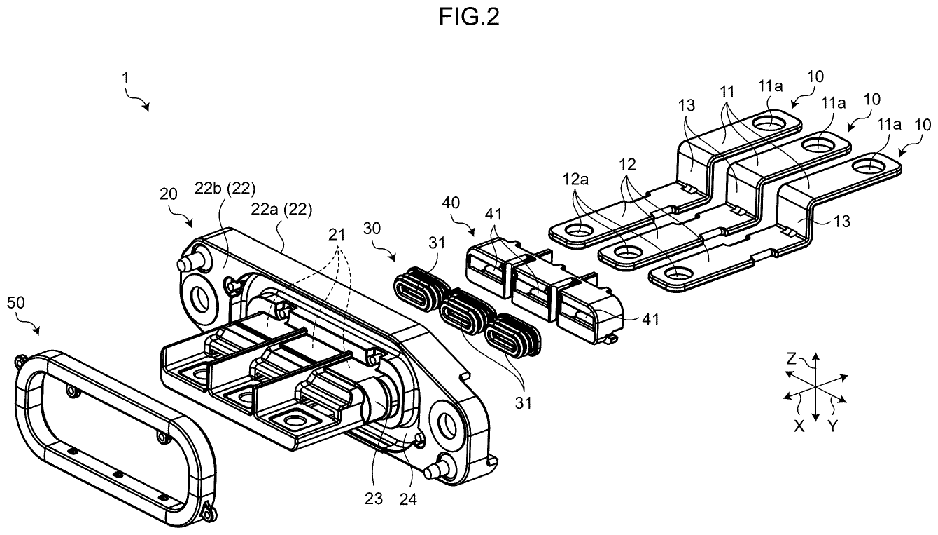

FIG. 2 is an exploded perspective view of the terminal block 1. As illustrated in FIG. 2, the terminal block 1 includes, for example, the plurality of bus bars 10, a housing 20, a packing 30, a packing holder 40, and a seal member 50. The plurality of bus bars 10 are terminal fittings made of a conductive metal material, and are electrically connected to the first connection terminal 3 and the second connection terminal 4 described above. In the present embodiment, the terminal block 1 is provided with three bus bars 10 arranged in the width direction Y. The number of the bus bars 10 is not limited to this example, and for example, one, two, or four or more bus bars 10 may be provided.

The bus bar 10 includes, for example, the first connection portion 11 provided at one end portion in the axial direction X, the second connection portion 12 provided at the other end portion in the axial direction X, and an intermediate portion 13 provided between the first connection portion 11 and the second connection portion 12. The first connection portion 11, the second connection portion 12, and the intermediate portion 13 are integrally formed of a conductive metal material. That is, the bus bar 10 is formed such that each portion is three-dimensionally integrated into a crank shape by performing various processing such as bending processing on one sheet of metal in accordance with the shape corresponding to each portion of the first connection portion 11, the second connection portion 12, and the intermediate portion 13.

The first connection portion 11 is a portion electrically and mechanically connected to the first connection terminal 3. The first connection portion 11 extends along the axial direction X. The first connection portion 11 is provided with an attachment hole 11a to which a bolt 61 (refer to FIG. 6) of a fastening member 60 for fastening the bus bar 10 and the first connection terminal 3 is attached. The attachment hole 11a is a through hole penetrating the first connection portion 11 along the plate thickness direction Z, and is configured as a round hole having a larger diameter than a shaft portion 61b of the bolt 61.

The second connection portion 12 is a portion electrically and mechanically connected to the second connection terminal 4. The second connection portion 12 extends along the axial direction X and is positioned to be shifted from the first connection portion 11 in the axial direction X and in the plate thickness direction Z. The second connection portion 12 is provided with an attachment hole 12a to which a bolt 71 (refer to FIG. 6) of a fastening member 70 for fastening the bus bar 10 and the second connection terminal 4 is attached. The attachment hole 12a is a through hole penetrating the second connection portion 12 along the plate thickness direction Z, and is configured as a round hole having substantially the same diameter as a shaft portion 71b of the bolt 71.

The intermediate portion 13 is a portion connected between the first connection portion 11 and the second connection portion 12. The intermediate portion 13 extends along the plate thickness direction Z and forms a step between the first connection portion 11 and the second connection portion 12. The intermediate portion 13 is bent at an angle of 90° with respect to the first connection portion 11 and the second connection portion 12, for example. The thickness direction of the intermediate portion 13 is along the axial direction X intersecting the plate thickness direction Z of the first connection portion 11 and the second connection portion.

The housing 20 holds the second connection portions 12 of the three bus bars 10 arranged in the width direction Y, and is formed of an insulating synthetic resin material. The housing 20 is provided with, for example, a housing main body 22 and a housing protrusion 23 protruding from the housing main body 22 to the side opposite to the bus bar 10 along the axial direction X. In the housing 20, the housing main body 22 and the housing protrusion 23 are integrally formed.

An insertion space portion 21 into which the second connection portion 12 of the bus bar 10 is inserted along the axial direction X is provided inside the housing main body 22 and the housing protrusion 23. The insertion space portion 21 penetrates the housing main body 22 and the housing protrusion 23 along the axial direction X. In the present embodiment, the housing 20 is provided with three insertion space portions 21 corresponding to the bus bars 10, and these three insertion space portions 21 are partitioned from each other in the width direction Y.

The housing main body 22 has one end face 22a on one side (bus bar 10 side) in the axial direction X and the other end face 22b on the other side in the axial direction X. The one end face 22a is a portion facing the intermediate portion 13 of the bus bar 10 in the axial direction X in a peripheral edge portion of the insertion space portion 21. The other end face 22b is a portion provided with a recess 24 for holding the seal member 50 in the peripheral edge portion of the housing protrusion 23. The recess 24 is recessed from the other end face 22b toward one side in the axial direction X and opened toward the other side in the axial direction X. The recess 24 is formed in, for example, a substantially elliptical annular shape along the outer shape of the seal member 50.

The seal member 50 suppresses entry of foreign matter such as moisture into the terminal block 1 through an annular gap between the housing 20 and a cylindrical portion (not illustrated) of the second device D2. The seal member 50 is formed of an elastically deformable member such as rubber or resin. The seal member 50 is formed in, for example, a substantially elliptical tubular shape and is fitted into the recess 24 described above. The seal member 50 is interposed between the other end face 22b of the housing main body 22 and an end face of a cylindrical portion (not illustrated) of the second device D2 in a state where the terminal block 1 is connected to the second device D2.

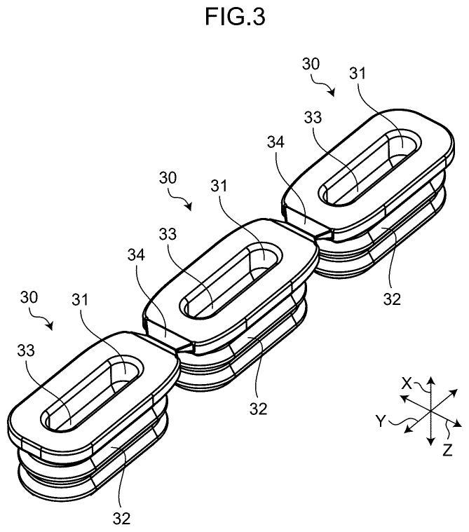

FIG. 3 is a perspective view of the packing 30 of the terminal block 1. As illustrated in FIG. 3, the packing 30 is provided with, for example, an insertion hole 31 through which the second connection portion 12 of the bus bar 10 is inserted along the axial direction X, and seals the periphery of the second connection portion 12. In the present embodiment, the terminal block 1 is provided with three packings 30 corresponding to the bus bars 10. For example, the three packings 30 are connected to each other via a coupling portion 34 provided between two adjacent packings 30 in the width direction Y. The packing 30 is formed of, for example, an elastically deformable member such as rubber. The packing 30 is also referred to as a terminal packing, a rubber plug, a bush, or the like.

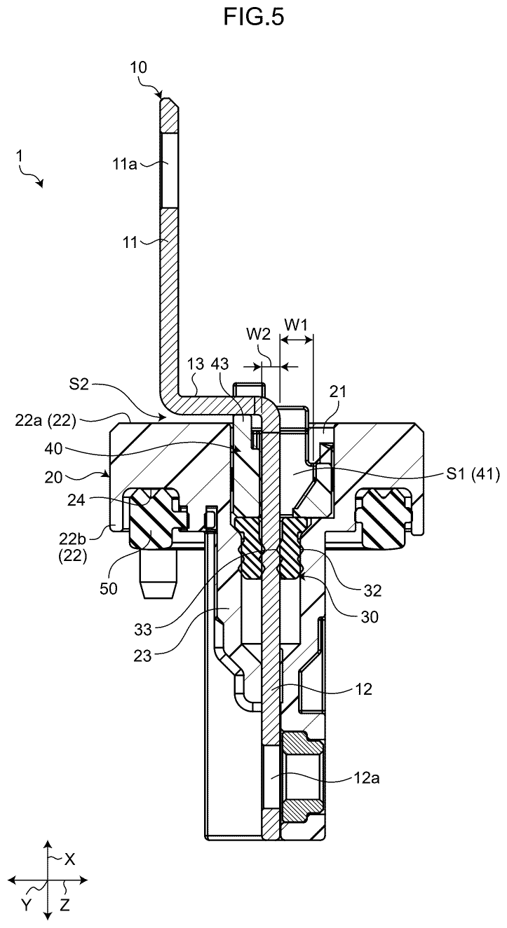

The packing 30 is provided with a plurality of outer peripheral lip portions 32 and a plurality of inner peripheral lip portions 33. The outer peripheral lip portion 32 is a pleated water stop portion formed in a substantially annular shape along the outer peripheral surface of the packing 30. In the present embodiment, the packing 30 is provided with two outer peripheral lip portions 32 arranged side by side in the axial direction X. In a state where the packing 30 is mounted in the insertion space portion 21 (refer to FIG. 5) of the housing 20, the outer peripheral lip portion 32 comes into contact with the inner surface of the insertion space portion 21 and waterproofs between the outer peripheral lip portion and the inner surface. The outer peripheral lip portion 32 is configured to come into close contact with the inner surface of the insertion space portion 21 by elastic deformation and seal the annular space between the inner surface and the outer peripheral surface of the packing 30.

The inner peripheral lip portion 33 is a pleated water stop portion formed in a substantially annular shape along the inner peripheral surface of the packing 30. In the present embodiment, the packing 30 is provided with two inner peripheral lip portions 33 (refer to FIG. 5) arranged side by side in the axial direction X. In a state where the second connection portion 12 of the bus bar 10 is inserted (press-fitted) into the insertion hole 31, the inner peripheral lip portion 33 comes into contact with the outer surface of the second connection portion 12 and waterproofs between the inner peripheral lip portion and the outer surface. The inner peripheral lip portion 33 is configured to come into close contact with the outer surface of the second connection portion 12 by elastic deformation and seal an annular space between the outer surface and the inner peripheral surface of the packing 30.

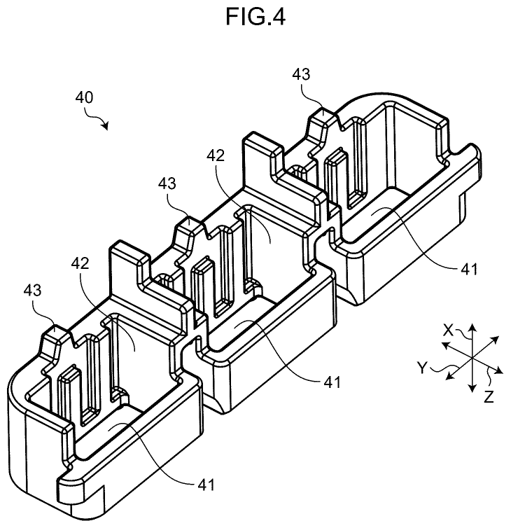

FIG. 4 is a perspective view of the packing holder 40 of the terminal block 1, and FIG. 5 is a sectional view of the terminal block 1. As illustrated in FIGS. 4 and 5, the packing holder 40 is provided with, for example, a bus bar insertion portion 41 through which the second connection portion 12 of the bus bar 10 is inserted along the axial direction X, supports the periphery of the second connection portion 12, and supports the packing 30 in the axial direction X. In the present embodiment, the packing holder 40 is provided with three bus bar insertion portions 41 corresponding to the bus bars 10. The three bus bar insertion portions 41 are partitioned from each other in the width direction Y via a partition wall 42 provided between two bus bar insertion portions 41 adjacent to each other in the width direction Y, for example. The packing holder 40 is formed of, for example, an insulating synthetic resin material.

In addition, the packing holder 40 is provided with, for example, a protrusion 43 provided on one end face in the axial direction X. The protrusion 43 protrudes from the packing holder 40 to one side in the axial direction X and supports the intermediate portion 13 (refer to FIG. 5) of the bus bar 10. That is, the protrusion 43 supports the intermediate portion 13 in a state of being separated from one end face of the packing holder 40 in the axial direction X. The packing holder 40 is inserted into the insertion space portion 21 of the housing 20 in a state where the second connection portion 12 is inserted into the bus bar insertion portion 41 and the packing 30 is supported in the axial direction X. The packing holder 40 functions as a portion that pushes the packing 30 toward the other side in the axial direction X (the back side) at the time of assembly to the insertion space portion 21.

In addition, in a state where the packing holder 40 is assembled to the insertion space portion 21, a second gap S2 is provided between the intermediate portion 13 and one end face of the packing holder 40 in the axial direction X and between the intermediate portion 13 and the one end face 22a of the housing 20 described above. The second gap S2 is a gap for allowing deformation of the intermediate portion 13 in the axial direction X.

Here, in the present embodiment, the bus bar insertion portion 41 is configured to include a first gap S1 for allowing deformation of the second connection portion 12 in the plate thickness direction Z. The first gap S1 is, for example, a gap between an inner surface on the other side in the plate thickness direction Z of the bus bar insertion portion 41 and the second connection portion 12 in a state where the second connection portion 12 is in contact with the inner surface on one side in the plate thickness direction Z of the bus bar insertion portion 41. In the present embodiment, an opening width W1 of the first gap S1 along the plate thickness direction Z is set to be larger than a thickness W2 of the second connection portion 12 along the plate thickness direction Z. The bus bar insertion portion 41 has an opening width obtained by adding the opening width W1 of the first gap S1 and the thickness W2 of the second connection portion 12.

Next, a tolerance absorbing structure at the time of assembly work on the first connection terminal 3 and the second connection terminal 4 of the terminal block 1 having the above configuration will be described. FIG. 6 is a sectional view of the terminal block 1 in a state where the bus bar 10 is deformed. As illustrated in FIG. 6, when the terminal block 1 is assembled to the first connection terminal 3 and the second connection terminal 4, first, the second connection portion 12 of the bus bar 10 and the second connection terminal 4 of the second device D2 are fastened and fixed by the fastening member 70.

Specifically, in the present embodiment, the fastening member 70 includes a bolt 71 and a nut 72, and the nut 72 is attached and fixed to the distal end portion of the housing protrusion 23 in advance in a state of being aligned in the plate thickness direction Z with the attachment hole 12a of the second connection portion 12. The bolt 71 is provided with the shaft portion 71b having an outer peripheral surface provided with a male screw portion that meshes with a female screw portion of the nut 72, and a head portion 71a having a larger diameter than the shaft portion 71b. In a state where the second connection terminal 4 and the second connection portion 12 are sandwiched between the head portion 71a and the nut 72, the shaft portion 71b of the bolt 71 penetrates the second connection terminal 4 and the second connection portion 12 in the plate thickness direction Z and is fastened to the nut 72.

Next, the first connection portion 11 of the bus bar 10 and the first connection terminal 3 of the first device D1 are fastened and fixed by the fastening member 60. Specifically, in the present embodiment, the fastening member 60 includes the bolt 61 and a nut 62, and the attachment hole 11a of the first connection terminal 3 to which the shaft portion 61b of the bolt 61 is attached is configured as a round hole for absorbing a dimensional tolerance between the first connection terminal 3 and the second connection terminal 4 to some extent. In a state where the first connection terminal 3 and the first connection portion 11 are sandwiched between a head portion 61a and the nut 62, the shaft portion 61b of the bolt 61 penetrates the first connection terminal 3 and the first connection portion 11 in the plate thickness direction Z and is fastened to the nut 62.

At this time, in the present embodiment, when the dimensional tolerance between the first connection terminal 3 and the second connection terminal 4 is relatively large, an external force obliquely downward between the axial direction X and the plate thickness direction Z is generated in the bus bar 10, and the stress concentrates in the vicinity of the intermediate portion 13 to deform a proximal end portion 12c of the second connection portion 12 along the plate thickness direction Z. The proximal end portion 12c is an end portion of the second connection portion 12 on the intermediate portion 13 side. In addition, the intermediate portion 13 may be deformed along the axial direction X due to stress concentrated in the vicinity of the intermediate portion 13. Accordingly, the terminal block 1 can absorb dimensional tolerance between the first connection terminal 3 and the second connection terminal 4.

As described above, in the terminal block 1 according to the present embodiment, the bus bar insertion portion 41 is configured to include a first gap S1 for allowing deformation of the second connection portion 12 in the plate thickness direction Z. With this configuration, the terminal block 1 can allow the second connection portion 12 to be deformed in the plate thickness direction Z by the first gap S1 at the time of assembly to the first connection terminal 3 and the second connection terminal 4. As a result, the terminal block 1 can absorb the tolerance between the first connection terminal 3 and the second connection terminal 4, and can further reduce the stress generated in the bus bar 10, thereby improving the assemblability with respect to the first connection terminal 3 and the second connection terminal 4.

In addition, in the terminal block 1 according to the present embodiment, the opening width W1 of the first gap S1 in the plate thickness direction Z is larger than the thickness W2 of the second connection portion 12 in the plate thickness direction Z. With this configuration, the terminal block 1 can secure, for example, a relatively wide space in which the second connection portion 12 is deformed along the plate thickness direction Z by the first gap S1 at the time of assembly to the first connection terminal 3 and the second connection terminal 4. In addition, for example, as compared with a case where the opening width of the bus bar insertion portion 41 including the first gap S1 along the plate thickness direction Z is configured to be substantially the same as or slightly larger than the thickness W2 of the second connection portion 12 along the plate thickness direction Z, that is, a case where the second connection portion 12 has no space to be deformed along the plate thickness direction Z or is relatively small, it is possible to further reduce the stress generated in the bus bar 10 at the time of assembly to the first connection terminal 3 and the second connection terminal 4.

Further, in the terminal block 1 of the present embodiment, the housing 20 has one end face 22a facing the intermediate portion 13 in the axial direction X at the peripheral edge portion of the insertion space portion 21, and the second gap S2 for allowing deformation of the intermediate portion 13 in the axial direction X is provided between the one end face 22a and the intermediate portion 13. With this configuration, the terminal block 1 can allow the intermediate portion 13 to be deformed in the axial direction X by the second gap S2 at the time of assembly to the first connection terminal 3 and the second connection terminal 4, for example. As a result, the terminal block 1 can absorb the tolerance between the first connection terminal 3 and the second connection terminal 4, and can thus improve the assemblability with respect to the first connection terminal 3 and the second connection terminal 4.

Further, in the present embodiment, the case where the second gap S2 for allowing the deformation of the intermediate portion 13 in the axial direction X is provided between the one end face 22a and the intermediate portion 13 has been exemplified, but the present invention is not limited to this example. For example, the one end face 22a and the intermediate portion 13 may be arranged in a state of being in contact with each other without providing the second gap S2.

In the terminal block according to the present embodiment, the bus bar insertion portion is configured to include a first gap for allowing deformation of the second connection portion in the plate thickness direction. With this configuration, the terminal block can allow the second connection portion to be deformed in the plate thickness direction by the first gap at the time of assembly to the first connection terminal and the second connection terminal. As a result, the terminal block can absorb the tolerance between the first connection terminal and the second connection terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar including a first connection portion extending along an axial direction and connected to a first connection terminal, a second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and extending along the plate thickness direction;
a housing provided with an insertion space portion into which the second connection portion of the bus bar is inserted along the axial direction;
a packing that is inserted into the insertion space portion together with the second connection portion and seals an annular space between an outer surface of the second connection portion and an inner surface of the insertion space portion; and
a packing holder provided with a bus bar insertion portion through which the second connection portion is inserted along the axial direction, the packing holder being inserted into the insertion space portion in a state where the second connection portion is inserted into the bus bar insertion portion, and the packing is supported in the axial direction, wherein
the bus bar insertion portion is configured to include a first gap for allowing deformation of the second connection portion in the plate thickness direction.

2. The terminal block according to claim 1, wherein
an opening width of the first gap along the plate thickness direction is larger than a thickness of the second connection portion along the plate thickness direction.

3. The terminal block according to claim 1, wherein
the housing includes one end face facing the intermediate portion in the axial direction at a peripheral edge portion of the insertion space portion, and
a second gap for allowing deformation of the intermediate portion in the axial direction is provided between the one end face and the intermediate portion.

4. The terminal block according to claim 2, wherein
the housing includes one end face facing the intermediate portion in the axial direction at a peripheral edge portion of the insertion space portion, and
a second gap for allowing deformation of the intermediate portion in the axial direction is provided between the one end face and the intermediate portion.
